(19) United States
(12) Patent Application Publication
(10) Pub. No.: US 2026/0037318 A1
(43) Pub. Date: Feb. 5, 2026

(54) INTERACTIVE INTERFACE TASK AUTOMATION UTILIZING GENERATIVE ARTIFICIAL INTELLIGENCE (AI) ACTION MODELS IMPROVED WITH RETRIEVAL-AUGMENTED GENERATION (RAG)

(71) Applicant: Microsoft Technology Licensing, LLC, Redmond, WA (US)

(72) Inventors: Ravi Theja YADA, Renton, WA (US); Amr Mahmoud Ahmed Bekhiet ALY, Redmond, WA (US); Sarvesh NAGPAL, Kirkland, WA (US); Sharon PENG, Miami, FL (US); Aamir JAWAID, Renton, WA (US)

(73) Assignee: Microsoft Technology Licensing, LLC, Redmond, WA (US)

(21) Appl. No.: 18/788,407

(22) Filed: Jul. 30, 2024

(51) Int. Cl. G06F 9/50

(52) U.S. Cl. CPC G06F 9/5038

(57) ABSTRACT

This disclosure describes a framework for performing user-requested tasks automatically across an interactive interface using various types of machine learning models. Specifically, this disclosure outlines and describes a task execution system that utilizes a generative artificial intelligence (AI) action model and retrieval-augmented generation (RAG) to complete user-requested actions across an interactive interface. The task execution system solves many of the current limitations of LAMs by using a generative AI action model to determine a session plan, which includes a set of actions for accomplishing stages of the actionable task across the interactive interface, obtaining visual context information of each interactive interface segment, integrates RAG results to improve the accuracy of both the session plan and individual actions, and self-corrects when faced with unexpected obstacles.

### BACKGROUND

In recent years, remarkable progress has been made in the field of artificial intelligence (AI), driven by advancements in both hardware and software. One notable development is the use of large action models (LAMs), which simulate user interactions with software interfaces. However, LAMs still face significant technical challenges. For instance, when a predicted action encounters an obstacle or fails, LAMs often produce an error message instead of the desired output. Furthermore, while LAMs are used to perform single actions, current systems struggle to accurately determine and execute a sequence of actions without continuous input from the user. These and other issues exist with current systems that use LAMs.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of a task execution system that utilizes generative artificial intelligence (AI) action models and retrieval-augmented generation (RAG) to complete user-requested actions on an interactive interface.

FIG. 2 illustrates an example computing environment in which the task execution system is implemented.

FIG. 3 illustrates an example sequence diagram of generating a session plan, which includes a set of actions, to accomplish the actionable task on the interactive interface.

FIG. 4 illustrates an example sequence diagram of generating and executing action schemes for actions included in the session plan to accomplish the actionable task on the interactive interface.

FIG. 5 illustrates an example flow diagram for using fallback actions and session plans to complete user-requested actions on the interactive interface.

FIGS. 6A-6D illustrate example graphical user interface diagrams for the task execution system automatically performing an actionable task on an interactive interface based on user input in a user query.

FIG. 7 illustrates an example series of acts of a computer-implemented method for performing complex tasks based on generative AI models using RAG inputs.

FIG. 8 illustrates example components included within a computer system used to implement the task execution system.

### DETAILED DESCRIPTION

This disclosure describes a framework for performing user-requested tasks automatically across an interactive interface using various types of machine learning models. Specifically, this disclosure describes a task execution system that utilizes a generative artificial intelligence (AI) action model and retrieval-augmented generation (RAG) to complete user-requested actions across an interactive interface. The task execution system solves many of the current limitations of LAMs by using a generative AI action model to determine a session plan, which includes a set of actions for accomplishing stages of the actionable task across the interactive interface, obtaining visual context information of each interactive interface segment, integrating RAG results to improve the accuracy of both the session plan and individual actions, and self-correcting when faced with unexpected obstacles.

Implementations of the present disclosure provide benefits and solve problems in the art with systems, computer-readable media, and computer-implemented methods that utilize the task execution system to automatically perform actionable tasks across an interactive interface by accurately generating and executing session plans using generative AI models and prior user session information. In particular, the task execution system utilizes a generative AI action model and a visual-based generative AI model, both supplemented with sanitized (e.g., anonymized) user session data from a RAG database. This enables the generation and execution of session plans to automatically perform a user-requested task across an interactive interface without requiring additional user input or interaction to perform the requested task and/or intermediary steps. Additionally, if obstacles are encountered, the task execution system can self-correct by performing alternate actions and/or generating an updated session plan.

As described in this disclosure, the task execution system delivers several significant technical benefits in terms of improved accuracy, efficiency, and flexibility compared to current systems. Moreover, the task execution system provides several practical applications that address problems related to improving the accuracy and efficiency of using generative AI action models to perform user-requested tasks.

As mentioned above, the task execution system improves the accuracy and efficiency of computing systems that utilize generative AI action models. To illustrate, by providing prior user session information corresponding to the user-requested actionable task and the interactive interface in a prompt, the generative AI action model creates improved session plans that are tailored to each segment of the interactive interface (e.g., webpages or application screens), which leads to more accurate actions and improved efficiency through fewer incorrect actions. In particular, by providing the prior session information to the generative AI action model and the visual-based generative AI model, the task execution system can determine preselected areas for the generative AI action model to understand and evaluate with respect to a given user prompt or request.

In various instances, the task execution system uses grounding information to improve both session plans and action schemes. To illustrate, a webpage includes several possible interactive elements. The prior user session information provides indications of commonly used elements. However, by using the visual context information (e.g., grounding information) from the visual-based generative AI model, the task execution system can determine the correct element to use and provide suggested directions or actions indicating such. By doing so, the task execution system significantly improves the efficiency and accuracy of executing an action scheme by quickly completing an action without incorrect or unnecessary interactive element selections.

Additionally, the task execution system improves the flexibility of computing systems. To illustrate, the task execution system enables actionable tasks to be automatically performed across various interactive interfaces, which previously were too complex to allow for such. Additionally, when obstacles are encountered or actions fail, the task execution system provides a framework for actionable tasks to self-correct by determining and performing alternate actions and/or generating an updated session plan. By doing so, the task execution system provides multiple paths to flexibility for accomplishing a user-requested task without requiring user intervention or returning error messages of failure to the user.

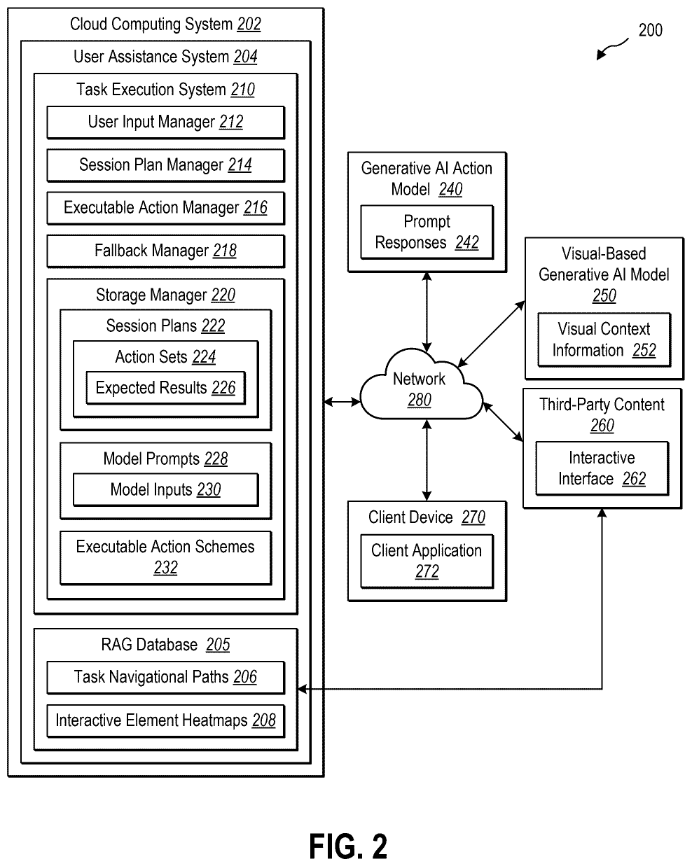

As illustrated in the preceding discussion, this disclosure uses a variety of terms to describe the features and advantages of one or more described implementations. For example, this disclosure describes search engine indexing in the context of a cloud computing system. As an example, the term “cloud computing system” refers to a network of interconnected computing devices that provide various services and applications to computing devices (e.g., server devices and client devices) inside or outside of the cloud computing system. An example of a cloud computing system is described below in connection with FIG. 2.

As an example, the term “actionable task” (or simply “task”) refers to an objective, goal, or target that can be accomplished. Completing a task often includes an exchange of information using an interactive interface. Tasks are often described in the document in the context of an interactive interface, such as performing a set of actions to traverse a segment of the interactive interface to accomplish an end goal. In many instances, a user provides a user query that includes user input requesting an actionable task with respect to an interactive interface.

As another example, the term “interactive interface” refers to a navigable graphical user interface that includes one or more interactive elements. An interactive interface may refer to a website, software program, or computer application. An interactive interface is a website with one or more web pages that each include selectable, fillable, and/or manipulated elements (e.g., “interactive elements”) that cause some data to change based on user actions. As another example, the term “interactive interface segment” refers to a portion of an interactive interface, such as a web page, an application screen, a single graphical user interface, or portions thereof. An interactive interface often provides various navigational paths across different interactive interface segments.

As an example, the term “session plan” refers to a framework, outline, summary, strategy, or blueprint for accomplishing an actionable task. In many instances, a session plan includes a set of actions that correspond to different stages or steps of accomplishing an actionable task. For example, a session plan includes a set of actions where some of the actions correspond to navigating through different interactive interface segments to arrive at a final segment where the task can be completed. In various implementations, one or more of the actions include a corresponding expected result, which indicates what should be observed when an action is successfully completed.

As another example, the term “action” refers to an interaction that a user may perform with respect to an interactive interface. For example, an action includes navigating to an element on an interactive interface segment, selecting an element, clicking an element, filling in a value in a text field, modifying a selection, or initiating content. An action in the set of actions may include one or more sub-acts performed by the task execution system with respect to an interactive interface (e.g., navigating to an element and selecting the element). In particular, an action may be performed by following an executable action scheme.

As an additional example, the term “executable action scheme” refers to one or more steps for accomplishing an action. For example, given an action and context information about an interactive interface or interactive interface segment, the task execution system generates an executable action scheme for accomplishing the action. If the action is successfully accomplished, the task execution system may move to the next action in the session plan. Otherwise, the task execution system may determine and perform an alternative executable action scheme for the action.

As an example, the terms “interactive interface heatmap,” “interactive element heatmap,” or often simply “heatmap” refer to a visual representation of user behavior and/or session data on an interactive interface. A heatmap provides a measure of user interactions, such as clicks, taps, and scrolls. For example, a heatmap can indicate the usage of interactive elements by a group of users visiting an interactive interface or interactive interface segment. Additionally, heatmaps can include different types of user behavioral information, such as active clicks, dead clicks, hover times, and interactive interface segment times. Heatmaps can include different colors or magnitudes to indicate areas with higher engagement and/or less activity. Heatmaps are often generated from user interactions with an interactive interface and/or interactive interface segment. Heatmaps and prior session information may be stored and used as retrieval-augmented generation (RAG) inputs.

As an example, the term “prior session information” refers to the behaviors and actions of previous users in relation to the interactive interface and interactive interface segments. Prior session information can include navigational paths, user inputs with interactive elements, navigational timing, and other user behaviors. In many or all implementations, personally identifiable information and/or sensitive user information is changed or removed from prior session information. In many implementations, a minimum number of user sessions is combined before being provided as prior session information to the task execution system.

As an example, the term “user query” (or simply “query”) refers to data received from a user regarding an actionable task. For example, the task execution system provides an interface that includes an input field for a user to provide user input in a query. The term “user input” refers to the input provided within the query that indicates an actionable task for the task execution system to automatically accomplish with little or no user interaction.

As an example, the term “machine learning model” refers to a computer model or computer representation that can be trained (e.g., optimized) based on inputs to approximate unknown functions. For instance, a machine learning model can include (but is not limited to) an autoencoder model, an embedding model, a classification model, a neural network (e.g., convolutional neural networks (CNNs), residual learning neural networks, recurrent neural networks (RNNs), generative neural networks, generative adversarial neural networks (GANs), and single-shot detection (SSD) networks), a decision tree (e.g., a gradient-boosted decision tree), a linear regression model, a logistic regression model, or a combination of these models.

As an example, the term “generative artificial intelligence model” (or “generative AI model”) refers to a computational system that utilizes deep learning and a large number of parameters (e.g., billions or trillions for a large version and fewer for a small version) that are trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations.

Moreover, generative AI models are primarily based on transformer architectures for understanding, generating, and manipulating human language. Generative AI models can also utilize other types of architectures such as RNN architecture, long short-term memory (LSTM) model architecture, CNN architecture, or other types of architectures. Examples of generative AI models include generative pre-trained transformer (GPT) models like GPT-3.5, GPT-4, and GPT-4o, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), a large action model (LAM), a small language model (SLM), and a small action model (SAM), which serve as text-based versions of a generative AI model, such as those that receive input prompts and generate output responses in the form of text, images, audio, and/or actions.

A generative AI model can include a generative AI action model and a visual-based generative AI model. As an example, the term “generative AI action model” refers to a generative AI model that can generate and execute complex, multi-step actions to accomplish an actionable task. In many implementations, a generative AI action model can generate a session plan that includes a set of actions for accomplishing a complex actionable task requested by a user through an interactive interface (e.g., a website or application).

As an example, the term “visual-based generative AI model” refers to a generative AI model that receives an image as input and provides visual context information as output. The visual context information is often provided as text, such as a sentence, a paragraph, and/or a list of items. In some instances, a visual-based generative AI model uses a combination of convolutional neural networks (CNNs) and transformers to generate high-quality visual content and/or extract visual features from an input image.

As another example, the terms “prompt,” “model prompt,” or “generative AI model prompt” refer to a request provided to a generative image model to create generative AI model output based on plain language guidance prompts. Examples of prompts, which are further described below, include a session plan generation prompt, an action execution prompt, a database query prompt, and a visual context prompt.

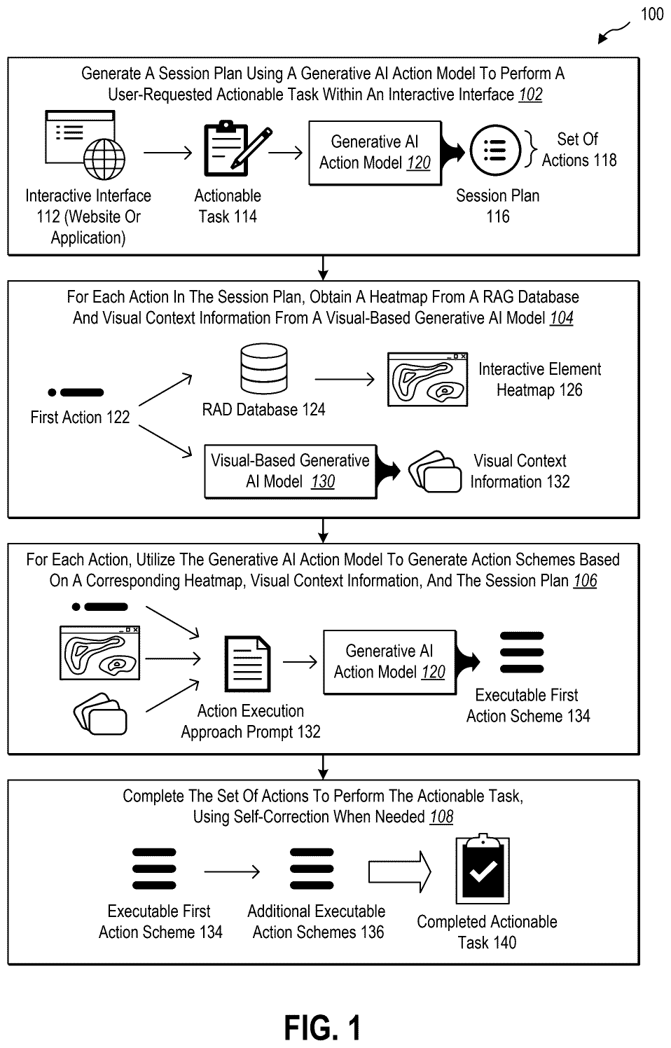

Implementation examples and details of the task execution system will be discussed in connection with the accompanying figures, which will be described next. For example, FIG. 1 illustrates an example of a task execution system that utilizes generative artificial intelligence (AI) action models and retrieval-augmented generation (RAG) to complete user-requested actions on an interactive interface according to some implementations. While FIG. 1 provides a high-level overview of the invention, additional details are provided in subsequent figures.

FIG. 1 illustrates a series of acts 100 performed by or under the direction of the task execution system. As shown, the series of acts 100 briefly illustrates an example of how the task execution system provides a framework that utilizes a generative AI action model, enhanced with session and visual context information to perform a set of actions and complete a task requested by the user.

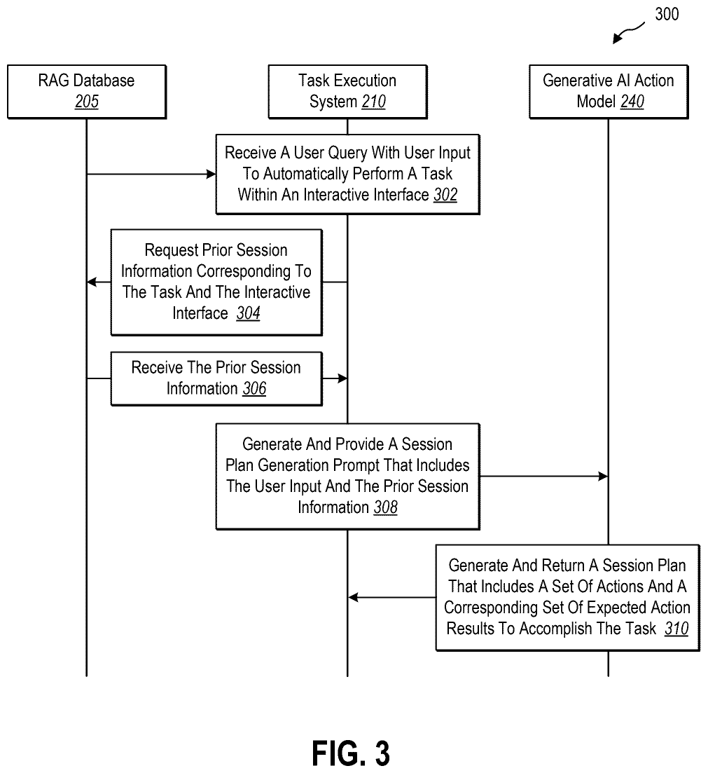

To elaborate, the series of acts 100 includes act 102 of generating a session plan using a generative AI action model to perform a user-requested actionable task within an interactive interface. For example, in connection with an interactive interface 112, such as a website or application, the task execution system provides a way for a user to submit a query or request to automatically perform an actionable task 114 on the interactive interface. In one or more implementations, the task execution system provides the actionable task 114 and other prior session information to a generative AI action model 120 with instructions to generate a session plan 116 that includes a set of actions 118. In various instances, the set of actions 118 provides a high-level framework for arriving at and completing the actionable task 114. Additional details about generating a session plan that includes a set of actions are provided below in connection with FIG. 3.

Act 104 includes obtaining a heatmap from a RAG database and visual context information from a visual-based generative AI model for each action in the session plan. While the session plan 116 includes a series of actions for arriving at the actionable task 114, the level of detail included in the session plan 116 for one or more actions may be insufficient to enable the task execution system to complete individual actions. Accordingly, in various implementations, for some or all of the actions, such as the first action 122, the task execution system obtains specific context information that it uses to determine a specific set of instructions or schemes for successfully accomplishing the action.

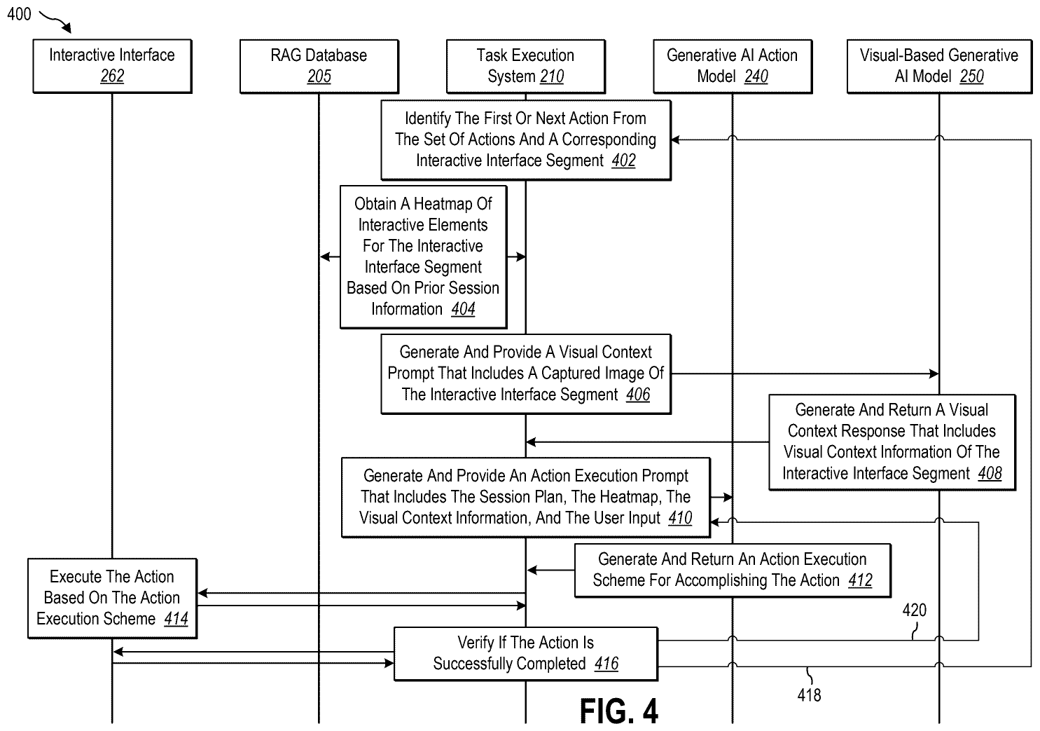

To illustrate, act 104 includes the task execution system obtaining an interactive element heatmap 126 from a RAD database 124 based on the first action. For instance, when the first action corresponds to an interactive interface segment, such as a webpage, the task execution system queries the RAD database 124 for the interactive element heatmap 126 corresponding to the webpage. Similarly, the task execution system prompts a visual-based generative AI model 130 to generate and provide visual context information 132 about the webpage. Additional details about obtaining action-specific and/or interactive interface segment-specific context information are provided below in connection with FIG. 4.

Act 106 includes utilizing the generative AI action model to generate action schemes based on a corresponding heatmap, visual context information, and the session plan for each action. For instance, the task execution system provides a prompt to the generative AI action model 120 to generate an executable first action scheme 134 for the first action 122. To enhance the accuracy and efficiency of the action models in generating an accurate and efficient action scheme, the task execution system can also provide context information corresponding to the first action 122 and/or interactive interface segment (e.g., webpage), such as the interactive element heatmap 126 and the visual context information 132 of the webpage. In addition, the task execution system provides the first action 122 and/or the session plan 116 to the generative AI action model 120. In response, the generative AI action model 120 generates an executable first action scheme 134 to accomplish the first action. Additional details about generating executable action schemes are provided below in connection with FIG. 4.

Act 108 includes completing the set of actions to perform the actionable task, using self-correction when needed. In various implementations, the task execution system follows the executable first action scheme 134 to accomplish the first action 122. As described below, the task execution system verifies that the first action 122 is successfully completed before proceeding to the next action, for which the task execution system determines and follows a corresponding executable action scheme to complete. Indeed, the task execution system completes additional executable action schemes 136 corresponding to the additional actions necessary to achieve a completed actionable task 140.

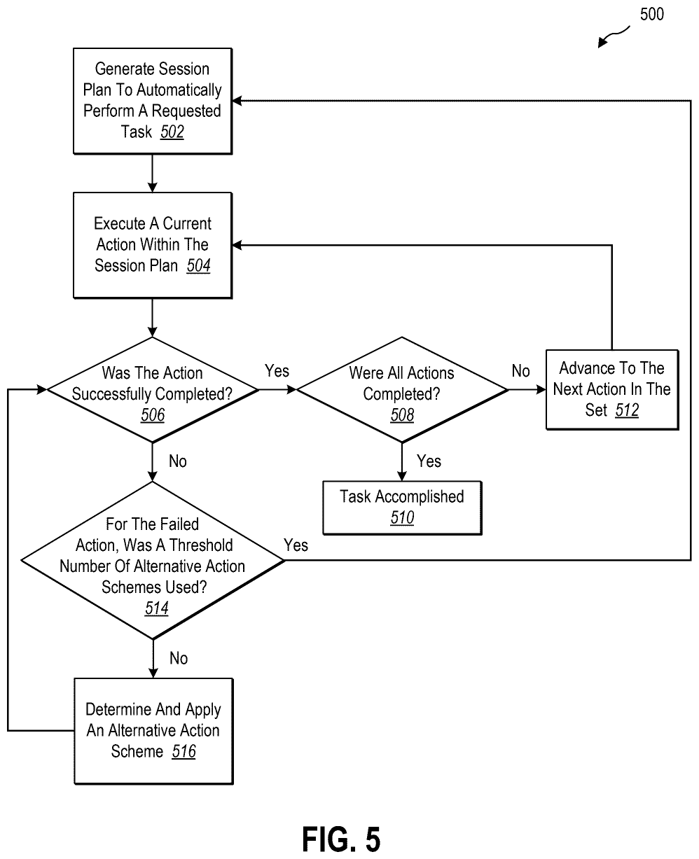

In some implementations, the task execution system encounters an obstacle while attempting to complete a task successfully. For example, the task execution system generates and follows the executable first action scheme 134 but does not successfully complete the first action 122. In these instances, the task execution system generates one or more alternative executable action schemes for the first action 122 until it is successfully completed. In some instances, if an action cannot be completed, the task execution system generates an updated session plan with one or more different actions. Additional details about using self-correcting or fallback actions and session plans are provided below in connection with FIG. 5.

With a general overview in place, additional details are provided regarding the components, features, and elements of the task execution system. To illustrate, FIG. 2 shows an example computing environment where the task execution system is implemented according to some implementations. In particular, FIG. 2 illustrates an example of a computing environment 200 with various computing devices including a cloud computing system 202 associated with a task execution system 210, a generative AI action model 240, a visual-based generative AI model 250, third-party content 260, and a client device 270, connected via a network 280. While FIG. 2 shows example arrangements and configurations of the computing environment 200, the cloud computing system 202, the task execution system 210, and associated components, other arrangements and configurations are possible.

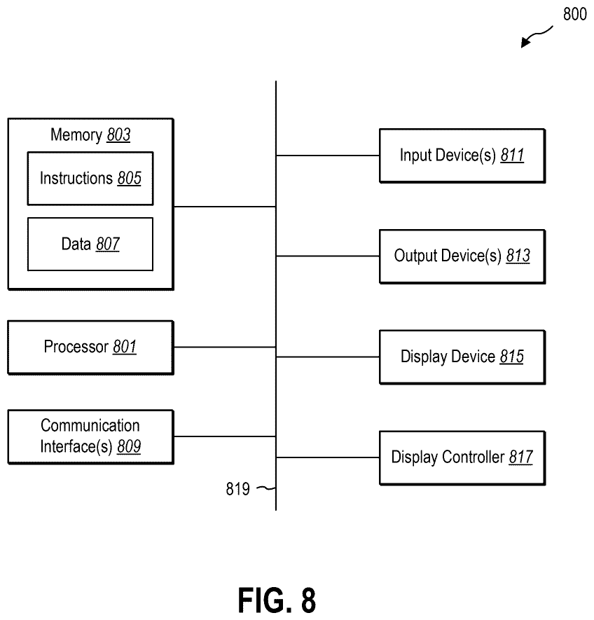

Many of these components shown may be implemented on one or more computing devices, such as on one or more server devices. In various implementations, some of these components (e.g., the cloud computing system 202, the generative AI action model 240, the visual-based generative AI model 250, the third-party content 260) represent multiple component instances or component versions (e.g., the generative AI action model 240 represents different versions of a generative AI model). In some implementations, one or more components are implemented on the same device (e.g., the generative AI action model 240 is a small action model implemented within the task execution system 210). Further details regarding computing devices are provided below in connection with FIG. 8, which also includes additional details regarding networks, such as the network 280 shown.

Before describing the components of the cloud computing system 202, including the task execution system 210, other components of the computing environment 200 are briefly discussed first to provide better context when describing the task execution system 210. For instance, the generative AI action model 240 receives various prompts and other inputs, processes the inputs, and generates prompt responses 242. For example, the generative AI action model 240 generates session plans and/or executable action schemes for accomplishing a user-requested task.

As shown, the cloud computing system 202 includes the visual-based generative AI model 250, which generates comprehensive grounding information and/or visual context information 252 from images (e.g., screenshots). The visual-based generative AI model 250 may return varying levels of image descriptions and grounding information based on the prompt it receives (e.g., a visual context information prompt or a grounding information prompt). In various implementations, the visual-based generative AI model 250 is a multimodal model that targets a specific category of grounding information.

The third-party content 260 represents content providers that offer content to client devices. In many instances, the third-party content 260 includes an interactive interface 262 that can have one or more interactive segments and/or interactive elements. The third-party content 260 commonly provides data and services accessible by navigating through the interactive interface 262. In some instances, the third-party content 260 includes services associated with the cloud computing system 202 to obtain prior user session information (e.g., navigational paths and heatmaps) to be stored in a retrieval-augmented generation (RAG) database.

As shown, the computing environment 200 includes the client device 270 with a client application 272. In some implementations, the client device 270 is associated with a user (e.g., a user client device). In various instances, the client application 272 is a web browser, mobile application, or another type of computer program that provides data and/or services to users. In some instances, the task execution system 210 is integrated into and includes a plugin or other extension to the client application 272 to perform requested actionable tasks automatically within the client application 272.

Returning to the cloud computing system 202, as shown, the cloud computing system 202 includes a user assistance system 204. The user assistance system 204 facilitates receiving user queries and inputs for answering user queries as well as receiving user requests to perform actionable tasks automatically with the interactive interface 262. As shown, the user assistance system 204 includes the task execution system 210 and a RAG database 205. The user assistance system 204 may include other systems and components not shown.

The RAG database 205 includes prior session information corresponding to users for various interactive interfaces associated with various content providers. In particular, the RAG database 205 includes task navigational paths 206 for the interactive interface 262 showing paths that users took to navigate through an interactive interface. In some implementations, one or more navigational paths are tied to a specific task. The RAG database 205 also includes interactive element heatmaps 208 indicating user activity for interactive interface segments. The RAG database 205 may include additional user behavioral information. As mentioned above, the user session data in the RAG database 205 is free of personally identifiable information (PII) and other sensitive user information.

The task execution system 210, in some implementations, is located on a separate computing device from the user assistance system 204 within the cloud computing system 202 (or apart from the cloud computing system 202). In various implementations, the task execution system 210 operates independently of the user assistance system 204.

In various implementations, including the illustrated implementation, the task execution system 210 includes various components and elements implemented in hardware and/or software. For example, the task execution system 210 includes a user input manager 212, a session plan manager 214, an executable action manager 216, a fallback manager 218, and a storage manager 220. The storage manager 220 includes session plans 222 with action sets 224 and expected results 226, model prompts 228 with model inputs 230, and executable action schemes 232.

To elaborate, in various implementations, the user input manager 212 receives and processes user input requesting actionable tasks to be automatically performed by the task execution system 210. In some implementations, the session plan manager 214 communicates with the RAG database 205 and the generative AI action model 240 (e.g., via model prompts 228 and model inputs 230) to obtain session plans 222 with action sets 224 and expected results 226.

In various implementations, the executable action manager 216 communicates with the RAG database 205, the visual-based generative AI model 250 (e.g., via model prompts 228 and model inputs 230), and the generative AI action model 240 (e.g., via model prompts 228 and model inputs 230) to generate executable action schemes 232 to complete the action sets 224 and achieve the expected results 226. In various implementations, the fallback manager 218 returns to the session plan manager 214 or the executable action manager 216 to generate alternative and/or backup actions and session plans when needed. Additional details regarding the functions of the task execution system 210 are provided below.

Turning to the next set of figures, these figures illustrate examples of the task execution system 210 performing different processes to generate and perform session plans and executable action schemes. To begin, FIG. 3 provides additional details about generating a session plan that includes a set of actions. In particular, FIG. 3 illustrates an example sequence diagram of generating a session plan to accomplish an actionable task on the interactive interface, according to some implementations.

As shown, the sequence diagram in FIG. 3 includes a series of acts 300 performed by the task execution system 210 or in response to instructions from the task execution system 210. FIG. 3 also includes the RAG database 205 and the generative AI action model 240, which interact with the task execution system 210 as part of generating session plans.

To begin, the series of acts 300 includes act 302 of the task execution system 210 receiving a user query with user input to automatically perform a task within an interactive interface. For instance, a client device is accessing a website or application that displays an interactive interface.

In various implementations, the task execution system 210 provides a user-input element or field for providing a user query or user input. For example, a user assistance system provides a user assistance tool where users can provide user queries or inputs, and when the user input corresponds to performing an actionable task, the user input is provided to the task execution system 210.

To illustrate, the interactive interface is a travel website for booking trips. Upon arriving at the website, the client device provides user input to the task execution system 210 requesting the task execution system 210 to automatically book a trip for the user and/or their family. In another example, the interactive interface is a grocery store application and the task execution system 210 receives user input to identify the ingredients needed to prepare a particular meal. Indeed, the task execution system 210 receives user input requesting it to automatically navigate through multiple steps or stages of the interactive interface (e.g., interactive interface segments) to arrive at and perform a requested action on behalf of the user.

Act 304 includes the task execution system 210 requesting prior session information corresponding to the task and the interactive interface from the RAG database 205. Act 306 includes the task execution system 210 receiving the prior session information from the RAG database 205. In one or more implementations, the task execution system 210 first obtains context information about the requested actionable task and the interactive interface. In many implementations, the task execution system 210 obtains this information from the RAG database 205 based on previous actions of other users with the interactive interface. In some instances, the actions are filtered to focus on prior user sessions that correspond to the requested actionable task.

To elaborate, in various implementations, the task execution system 210 provides queries to the RAG database 205, requesting prior user session information. For example, the task execution system 210 queries the RAG database 205 to provide navigational paths from the interactive interface segment where the client device is currently located to the interactive interface segment where the task can be accomplished. By doing so, the task execution system 210 has a collection of different routes through the interactive interface (e.g., website or application), which can be used to accomplish the task. Additionally, the task execution system 210 queries the RAG database 205 to provide interactive element heat maps for each interactive interface segment (e.g., for each webpage or application user interface) included in the navigational paths.

In various implementations, the queries can include various filters based on device type. For example, if the client device of the user is using a mobile device, the task execution system 210 requests prior session information from users with the same or similar mobile devices. Similarly, if the client device of the user is using a desktop or laptop device, the task execution system 210 requests prior session information from users with the same or similar computing devices. Often, a content provider offers different interactive interfaces to accommodate the capabilities of different client devices. These different interactive interfaces cause users to behave differently. Accordingly, the task execution system 210 can obtain prior session information that corresponds to the same or similar device as the client device providing the user input request.

In some implementations, the queries can include various filters based on location, recency, user type, and/or other factors. For example, the task execution system 210 provides queries that request prior session information from the same country as the requesting client device and/or from a particular time period (e.g., a day, week, or month). In some implementations, the task execution system 210 provides queries that match user types to the requesting user (e.g., demographics or other user characteristics).

In one or more implementations, the task execution system 210 provides different levels of query specificity or granularity. For example, the task execution system 210 provides a high-level query requesting prior session information about the interactive interface corresponding to the requested task (e.g., other users who started and/or completed the same or similar task), a more specific query that adds a filter of similar client devices, and an even more specific query that further adds a filter based on geographic location. The task execution system 210 can continue to add additional query filters and/or submit different combinations of query filters to the RAG database 205. Furthermore, the task execution system 210 can submit these queries concurrently (e.g., in parallel) to the RAG database 205.

To further illustrate providing queries of different granularities, suppose a client device displayed a department store website, and the task execution system 210 received a requested task of buying a pair of men's athletic shoes. In response, the task execution system 210 may generate and provide various queries to the RAG database 205 for previously corresponding user session data. The queries can request prior session information for user sessions that include purchased items, items added to a virtual cart (e.g., almost purchased items), purchased and/or almost purchased men's shoes, and purchased and/or almost purchased men's dress shoes. In some instances, some of these queries will return empty or null results if there is insufficient prior user session data.

In various instances, the task execution system 210 utilizes the generative AI action model 240 or another generative AI model to generate queries to send to the RAG database 205 for prior session information. For example, the task execution system 210 provides a prompt that includes the query architectures, the scope of available data, and possible filters to a generative AI model along with instructions to generate queries for obtaining prior session information based on the requested task and the interactive interface.

Act 308 includes the task execution system 210 generating a session plan generation prompt that includes the user input and prior session information. For example, the task execution system 210 generates a prompt for the generative AI action model 240 instructing the action model to generate a session plan that includes a set of actions for optimally navigating through the interactive interface and accomplishing the requested task. For each action in the set, the task execution system 210 can also instruct the action model to provide an expected result by which the action can be measured for successful completion.

As mentioned earlier, the session plan generation prompt can include prior session information. For example, the prompt includes task navigational paths and interactive element heatmaps received from the RAG database 205. The prompt can also include a specified output format (e.g., layout and/or file type) for the session plan and/or examples of session plans to follow.

Act 308 also includes the task execution system 210 providing the session plan generation prompt to the generative AI action model 240. In response, the generative AI action model 240 generates a session plan response that includes a set of actions and a corresponding set of expected action results to accomplish the task, as shown in act 310. For example, the generative AI action model 240 follows the instructions in the session plan generation prompt, using the prior session information as an augmented resource, to generate a session plan.

In various implementations, the generative AI action model 240 generates a session plan that analyzes each of the navigational paths and determines an optimal or near-optimal path for accomplishing the requested task. Then, for each stage or interactive interface segment along the determined path, the task execution system 210 uses the interactive element heatmaps to generate one or more actions.

As mentioned above, the session plan includes a set of actions for accomplishing the requested task along with a set of expected results (i.e., expected observations) for each action. In some instances, a task may not include a corresponding expected result. In various implementations, each action in the set corresponds to a different interactive interface segment. In some implementations, multiple actions correspond to the same interactive interface segment.

Act 310 includes the generative AI action model 240 returning the session plan to the task execution system 210. For instance, the task execution system 210 receives a session plan response that includes the session plan for accomplishing the requested task through and/or across the interactive interface.

Upon receiving the session plan, the task execution system 210 can execute each action to accomplish the requested task. As mentioned above, FIG. 4 provides additional details regarding obtaining action-specific and/or interactive interface segment-specific context information and generating executable action schemes. In particular, FIG. 4 illustrates an example sequence diagram of generating and executing action schemes for actions included in the session plan to accomplish the actionable task on the interactive interface.

To elaborate, actions in a set of actions provide a general directive with respect to a given interactive interface segment. However, in many cases, the action does not indicate how to perform the action nor provide instructions for accomplishing the action. Accordingly, in these cases, the task execution system 210 determines an executable action scheme, which provides instructions for completing the action.

As shown, the sequence diagram in FIG. 4 includes a series of acts 400 performed by the task execution system 210 or in response to instructions from the task execution system 210. FIG. 4 also includes the interactive interface 262, the RAG database 205, the generative AI action model 240, and the visual-based generative AI model 250.

The series of acts 400 includes act 402 of the task execution system 210 identifying the first or next action from the set of actions and a corresponding interactive interface segment. The actions in the set of actions often occur in a specific sequence. Accordingly, when initiating the action process, the task execution system 210 selects the first action in the set or sequence of actions. If returning to the set of actions, the task execution system 210 selects the next action in the set.

Act 404 includes the task execution system 210 obtaining a heatmap of interactive elements for the interactive interface segment based on prior session information. As mentioned above, actions generally correspond to interactive interface segments, such as a webpage of a website, an application interface, or another type of user interface. Accordingly, for the selected action, the task execution system 210 can provide one or more queries to the RAG database 205 to obtain heatmap information for the corresponding interactive interface segment. In response, the RAG database 205 provides responses to the one or more queries with one or more corresponding heatmaps.

As described above, the task execution system 210 may request queries that vary in specificity or granularity. For example, the task execution system 210 provides database queries that request a general heatmap of a webpage, as well as webpage heatmaps based on client device type, location, user type, and/or recency.

Act 406 includes the task execution system 210 generating and providing a visual context prompt to the visual-based generative AI model 250, where the visual context prompt includes a captured image of the interactive interface segment. In various implementations, the task execution system 210 captures a screenshot of the interactive interface segment and provides the screenshot to the visual-based generative AI model 250 with a visual context prompt to analyze the image, identify interactive elements, and return visual context information about the image.

In some implementations, the task execution system 210 also provides the prior session information of the interactive interface segment with the visual context prompt. By doing so, the visual-based generative AI model 250 can use the additional information to augment its findings to provide improved visual context information by correlating heatmap information with interactive elements. In some implementations, the visual context prompt includes a particular interactive interface to focus on when providing visual context information.

Act 408 includes the visual-based generative AI model 250 generating and returning a visual context response that includes visual context information of the interactive interface segment. For example, using the screenshot and any other provided input, the visual-based generative AI model 250 analyzes the inputs and determines the visual context of the interactive interface segment. The visual-based generative AI model 250 may return a text summary of the visual context, which can include one or more sentences and/or one or more bullet items. In some implementations, the visual context information includes an annotated image of the screenshot.

Act 410 includes the task execution system 210 generating and providing an action execution prompt to the generative AI action model 240, where the prompt includes the session plan, the heatmap, the visual context information, and the user input. In some instances, the prompt also includes the selected action and/or the screenshot of the interactive interface segment. Additionally, the prompt includes instructions, and in some cases examples, for generating an action execution scheme for performing the selected action on the interactive interface segment based on the inputs.

In some instances, the task execution system 210 determines a discrepancy between the interactive interface segment, the heatmap, and/or the visual context information. For example, if a webpage recently changed layout, prior session information and heatmaps from the previous layout are no longer relevant. In some instances, the task execution system 210 obtains more recent heatmap data or does not provide heatmap data with the action execution prompt.

Act 412 includes the generative AI action model 240 generating and returning an action execution response that provides an action scheme for accomplishing the action. In various implementations, the generative AI action model 240 provides the action execution prompt to generate a set of instructions for completing the selected action on the interactive interface segment. The generative AI action model 240 can use the other inputs, such as heatmaps or visual context information to generate the action execution scheme.

As mentioned, the action execution scheme may provide one or more instructions. For example, the action execution scheme includes directions to select an interactive interface, populate one or more fields with one or more specific values, navigate to a particular area within the interactive interface segment, and/or otherwise manipulate an interactive element. An action execution scheme can include multiple instructions for an interactive interface segment.

Act 414 includes the task execution system 210 executing the action on the interactive interface 262 based on the action execution scheme. For example, the task execution system 210 follows the instructions in the action execution scheme to complete the selected action. For instance, the task execution system 210 follows instructions in the action execution scheme to identify a target interactive element within the interactive interface segment and perform a specified act on the element. In some instances, the action execution scheme includes performing acts on multiple interactive elements within an interactive interface segment. In many instances, the action is complete when the interactive interface updates to a new segment (e.g., loads a new webpage or interface). In some instances, the task execution system 210 directs the generative AI action model 240 or another system to perform the instructions included in the action execution scheme.

Act 416 includes the task execution system 210 verifying if the action is successfully completed. For example, upon completing the acts in the action execution scheme, the task execution system 210 identifies the current state of the interactive interface 262. For example, if the interactive interface 262 updates to a new interactive interface segment, the task execution system 210 identifies the updated and/or modified state.

Furthermore, in various implementations, the task execution system 210 compares the current state of the interactive interface 262 to an expected result paired with the selected action within the session plan. For example, the task execution system 210 determines whether the updated state of the interactive interface 262 matches or is equivalent to an expected observation for the action when completed. In some implementations, the task execution system 210 uses a generative AI model or another model to verify and determine if the updated state or version of the interactive interface 262 matches or is equivalent to the expected result.

If the expected result for the selected action is verified and/or satisfied, the task execution system 210 performs act 418 of advancing to the next action in the set of actions (e.g., returning to act 402 and repeating the series of acts 400 for the next action). The task execution system 210 may continue to repeat the series of acts 400 until all of the actions in the action set are completed and the requested task is complete.

On the other hand, if the expected result for the selected action is not satisfied, the task execution system 210 performs act 420 of returning to generate an alternative action execution scheme (e.g., returning to act 410). For example, the task execution system 210 generates an updated action execution prompt that again instructs the generative AI action model 240 to generate an action execution scheme from the selected action. Additionally, the prompt can include previous action execution schemes from the selected actions that have not been successful, so that the generative AI action model 240 can generate and return action execution schemes that include one or more different directions.

The task execution system 210 can continue to perform the series of acts 400 until all of the acts in the set of actions are completed successfully. Alternatively, when an action is repeatedly unsuccessful for a threshold number of attempts, the task execution system 210 may fall back to an alternative session plan, as discussed in connection with the next figure.

As mentioned above, FIG. 5 provides additional details about using self-correcting or fallback actions and session plans. In particular, FIG. 5 illustrates an example flow diagram for using fallback actions and session plans to complete user-requested actions on the interactive interface according to some implementations.

As shown, FIG. 5 includes a series of acts 500 performed by the task execution system 210. For instance, the series of acts 500 includes act 502 of the task execution system 210 generating a session plan to automatically perform a requested task. FIG. 3 above provides an example of generating a session plan to automatically perform a requested task across a target interactive interface. For example, the task execution system 210 generates a session plan that includes a set of actions and a corresponding set of expected results.

Act 504 includes the task execution system 210 executing a current action within the session plan. FIG. 4 above provides an example of selecting a first or next action in the set of actions and executing it according to an action execution scheme.

Act 506 includes the task execution system 210 determining whether the action was successfully completed. If the action was successfully completed (i.e., “yes”), the series of acts 500 proceeds to act 508 of determining whether all actions were completed. If yes, the series of acts 500 concludes with act 510 of the task being accomplished. However, if not all the actions are completed (i.e., “no”), the series of acts 500 proceeds to act 512 of the task execution system 210 advancing to the next action in the set before returning to act 504 of executing the current action.

If, in act 506, the task execution system 210 does not successfully complete the action (i.e., “no”), the series of acts 500 proceeds to act 514 of the task execution system 210 determining, for the failed action, whether a threshold number of backup action schemes were used for the failed action. If no, the task execution system 210 performs act 516 of determining and applying an alternative action scheme. As described above in connection with FIG. 4, the task execution system 210 utilizes a generative AI action model to generate an alternative action execution scheme and uses it to attempt to successfully complete the action. As shown, act 516 then returns to act 506.

If, for a failed action, the threshold number of alternative action schemes is reached (e.g., 3, 5, 8, or 10), the task execution system 210 returns to act 502 to generate a new session plan. For example, the task execution system 210 updates the session plan generation prompt (e.g., taking a different approach to accomplish the task), incorporating some or all of the previous one or more session plan responses and additional instructions to generate a new session plan that differs from the previous session plans.

In various implementations, the updated session plan includes information about which action from the prior plan failed, so that the action model can learn and adapt from it (e.g., as additional augmented input data). The task execution system 210 can then repeat the series of acts 500 with the updated session plan. By doing so, the task execution system 210 provides another self-correcting fallback that allows the task execution system 210 to perform the requested task without user intervention, even when obstacles are encountered.

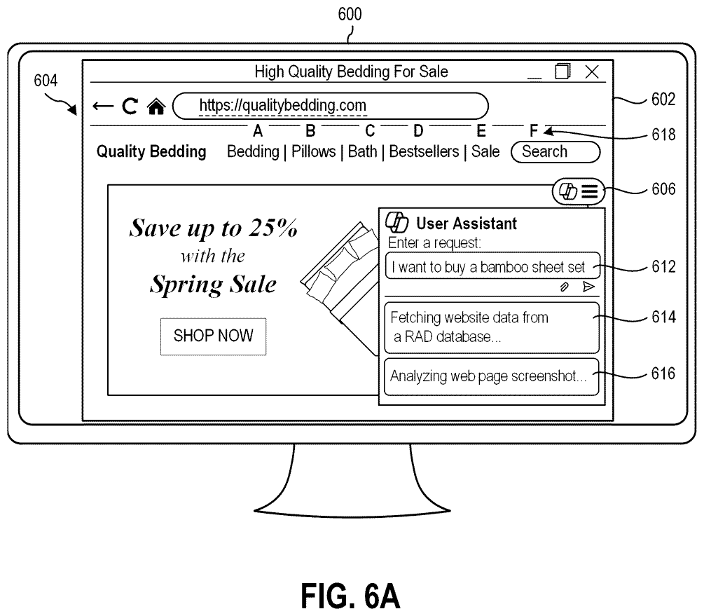

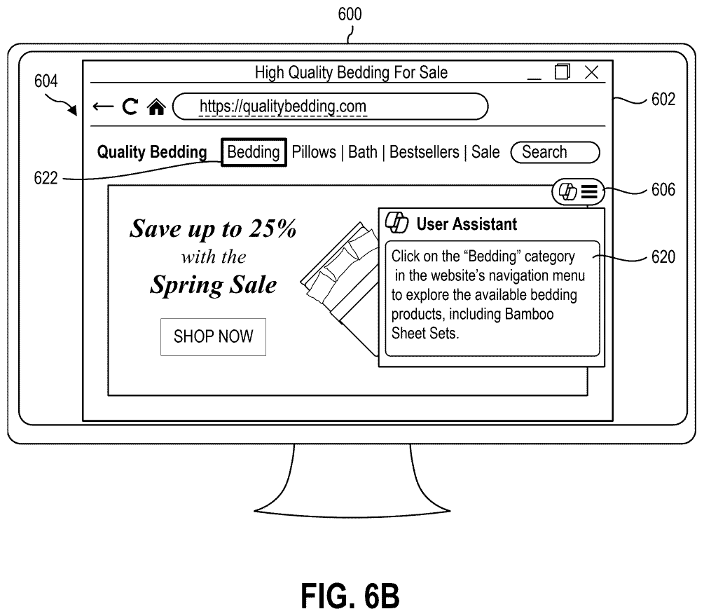

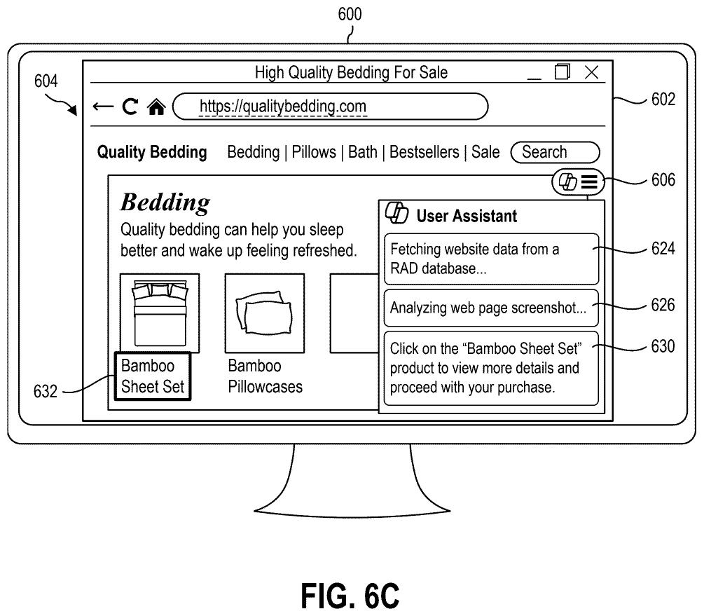

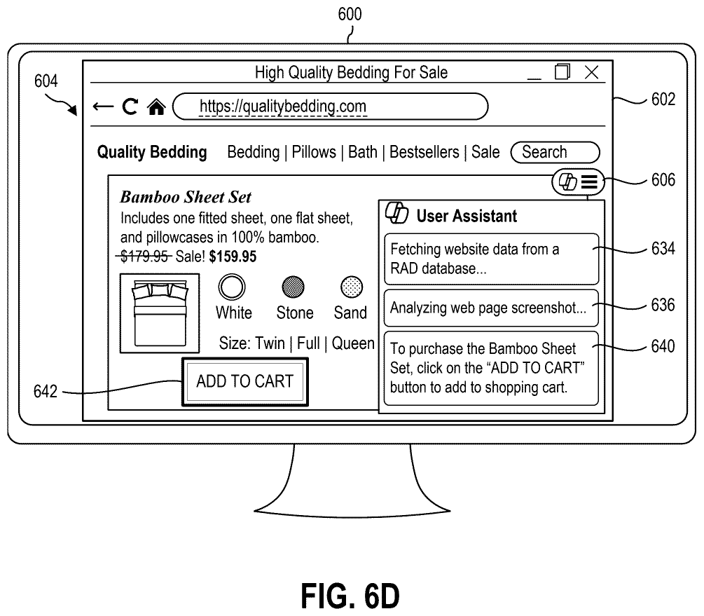

FIGS. 6A-6D illustrate example graphical user interface diagrams for the task execution system automatically performing an actionable task on an interactive interface based on user input in a user query according to some implementations. As shown in FIGS. 6A-6D, there is a computing device 600, which may correspond to the client device 270 introduced above and may be associated with a user. The computing device 600 includes a client application 602, such as a web browser. In some implementations, the computing device 600 is a mobile device and the client application 602 is a mobile application.

As shown in FIGS. 6A-6D, the client application 602 allows a user to access a website 604, such as the bedding website shown. The website 604 also includes a user assistant tool 606 where a user can provide user queries that include questions. In particular, the user assistant tool 606 allows a user, via the computing device 600, to provide user input requesting that a task be automatically performed on the website 604.

To illustrate, FIG. 6A shows the user assistant tool 606 receiving the user input 612 requesting to purchase a bamboo sheet set. In response, the user assistant tool 606 provides the user input 612 to the task execution system 210 to process the request, as described above. For example, the task execution system 210 fetches data from a RAD database (e.g., obtains prior session information) used to generate a session plan and action execution schemes for actions within the plan. In addition, the task execution system 210 analyzes the website page screenshot (e.g., obtains visual context information) used to generate action execution schemes, as described above.

As shown, the task execution system 210 identifies interactive elements 618 (shown as different letters) within an interactive interface segment (e.g., webpage) of the interactive interface (e.g., the website). The task execution system 210 may use prior session information, visual context information, and/or other approaches to identify the interactive elements 618 within the website 604. In various implementations, the task execution system 210 determines element types for the interactive elements 618 (e.g., link, text box, media, search field). In some instances, an interactive element is associated with multiple element types. While the interactive element labels are shown in FIG. 6A for explanation purposes, the task execution system 210 hides the labels from display. In alternative implementations, the task execution system 210 displays the labels.

In various implementations, the task execution system 210 provides visual indications of the actions occurring in the background. For example, the task execution system 210 displays a fetching data indication 614 (e.g., fetching website data from a RAD database) and a screenshot analysis indication 616 (e.g., analyzing web page screenshot), as shown. In various implementations, the task execution system 210 displays additional, different, or fewer indications.

FIG. 6B represents the task execution system 210 creating and performing an action execution scheme for a first action within a session plan. As shown, the task execution system 210 provides an action execution notification 620 of how it will perform the first action as part of performing the task of buying a bamboo sheet set. Additionally, FIG. 6B shows a first target interactive element 622 that the task execution system 210 identifies as part of executing the first action (e.g., selecting the bedding link). For instance, the task execution system 210 identifies and selects the first target interactive element 622 to complete the first action (e.g., navigating to a bedding webpage). In various implementations, the task execution system 210 verifies that the first action is successfully completed, as provided above.

FIG. 6C shows the website 604 updated to show a new interactive interface segment based on completing the first action and beginning a second action. In particular, FIG. 6C shows the task execution system 210 fetching prior session information (indicated by a second fetching data indication 624) and visual context information (indicated by the second screenshot analysis indication 626) for the second interactive interface segment (e.g., the second webpage) of the website.

In addition, FIG. 6C shows the task execution system 210 creating and performing an action execution scheme for a second action within the session plan. As shown, the task execution system 210 provides a second action execution notification 630 of how it will perform the second action (e.g., selecting the bamboo bed set product). Additionally, FIG. 6C shows a second target interactive element 632 (e.g., the bamboo bed set link) that the task execution system 210 identifies as part of executing the second action (e.g., navigating to a product webpage for a bamboo sheet set). For instance, the task execution system 210 identifies and selects the second target interactive element 632 to complete the second action.

FIG. 6D shows the website 604 updated to show another new interactive interface segment based on completing the second action and beginning a third action. FIG. 6D also shows the task execution system 210 fetching prior session information (indicated by a third fetching data indication 634) and visual context information (indicated by the third screenshot analysis indication 636) for the third interactive interface segment (e.g., the third webpage) of the website.

As with the above actions, FIG. 6D shows the task execution system 210 creating and performing another action execution scheme for a third action within the session plan. As shown, the task execution system 210 provides a third action execution notification 640 of how it will perform the third action (e.g., automatically adding a bamboo sheet set to a virtual cart). Additionally, FIG. 6D shows a third target interactive element 642 (e.g., add to cart button) that the task execution system 210 identifies as part of executing the third action. For instance, the task execution system 210 identifies and selects the third target interactive element 642 to complete the third action.

In some implementations, the task execution system 210 continues until the sheets are purchased. In some implementations, the task execution system 210 pauses for final user confirmation after adding the bamboo sheet set to the cart. In various implementations, the task execution system 210 allows a user to pause, interrupt, or stop the automatic process.

In some implementations, the task execution system 210 pauses to allow a user to select personalized options, such as styles, colors, and sizes, and/or provide necessary user input, such as name, address, and payment information. In various implementations, the task execution system 210 anticipates these selection options when generating the session plan and prompts the user for selection before or during the automation process. In some implementations, the task execution system 210 accesses user profile information to automatically determine missing data for the user.

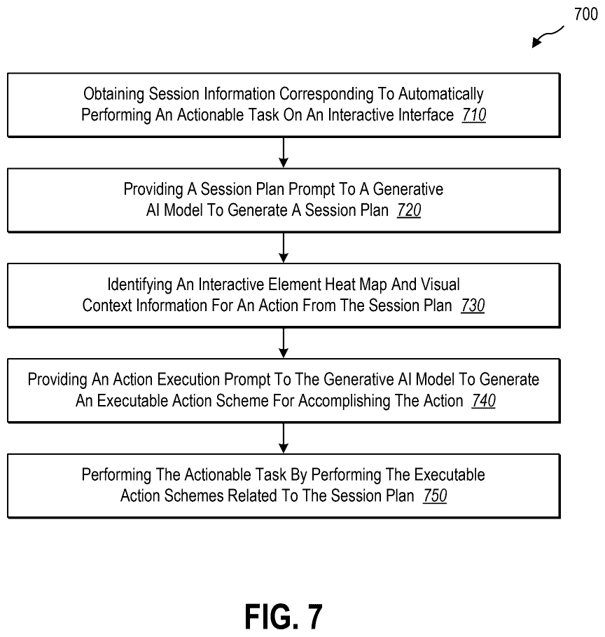

Turning now to FIG. 7, this figure illustrates an example series of acts of a computer-implemented method for performing one or more complex tasks based on one or more generative artificial intelligence (AI) action models using retrieval-augmented generation (RAG) inputs according to some implementations. While FIG. 7 illustrates acts according to one or more implementations, alternative implementations may omit, add to, reorder, and/or modify any of the acts shown.

The acts in FIG. 7 can be performed as part of a method (e.g., a computer-implemented method). Alternatively, a computer-readable medium can include instructions that, when executed by a processing system with a processor, cause a computing device to perform the acts in FIG. 7. In some implementations, a system (e.g., a processing system comprising a processor) can perform the acts in FIG. 7. For example, the system includes a processing system and a computer memory including instructions that, when executed by the processing system, cause the system to perform various actions or steps.

As shown, the series of acts 700 includes act 710 of obtaining session information corresponding to automatically performing an actionable task on an interactive interface. For instance, in example implementations, act 710 involves obtaining prior session information corresponding to the actionable task and the interactive interface in response to receiving user input indicating an actionable task to be automatically performed on an interactive interface.

In some implementations, act 710 includes receiving a user query including the user input to automatically perform the actionable task on the interactive interface and providing one or more session information queries to the RAG database to obtain the prior session information corresponding to the actionable task and the interactive interface. In some implementations, generating a first session information query at a first specificity level corresponding to the actionable task on the interactive interface, generating a second session information query at a second specificity level corresponding to the actionable task on the interactive interface, where the first specificity level differs from the second specificity level, and providing the first session information query and the second session information query in parallel to the RAG database.

In various implementations, obtaining the prior session information includes identifying the device type of the client device that provided a user query with the user input, generating a query request that requests the prior session information generated by prior users with the same device type as the device type, and providing the query request for the prior session information corresponding to the interactive interface. In some implementations, the interactive interface includes a mobile application provided by a mobile device, and obtaining the prior session information includes providing a query request for the prior session information corresponding to prior user sessions that interacted with the mobile application associated with mobile devices.

In some implementations, the interactive interface includes a website provided by a client device, and obtaining the prior session information includes providing a query request for the prior session information corresponding to prior user sessions that interacted with the website associated with client devices similar to the client device.

As further shown, the series of acts 700 includes act 720 of providing a session plan prompt to a generative AI action model to generate a session plan. For instance, in example implementations, act 720 involves providing a session plan generation prompt, which includes the prior session information, to a generative AI action model to generate a session plan that includes a set of actions for performing the actionable task. In some implementations, act 720 includes receiving the session plan from the generative AI action model in response to the session plan generation prompt. The session plan includes the first action and an expected first action result indicating an expected result of accomplishing the first action.

In some implementations, the set of actions in the session plan provides a framework for navigating through different interactive interface segments of the interactive interface to automatically accomplish the actionable task. In some implementations, act 720 includes generating the session plan generation prompt that includes the prior session information and the user input, providing the session plan generation prompt to the generative AI action model, and receiving a session plan response that includes the session plan, wherein the session plan includes the set of actions and a corresponding set of expected action results.

As further shown, the series of acts 700 includes act 730 of identifying an interactive element heatmap and visual context information for an action from the session plan. For instance, in example implementations, act 730 involves identifying an interactive element heatmap from a RAG database and visual context information from a visual-based generative AI model for a first action from the set of actions. In some instances, the interactive element heatmap indicates interactive elements usage by previous users. In some implementations, act 730 includes identifying a first interactive interface segment from the interactive interface associated with the first action, generating an interactive element query for obtaining the interactive element heatmap of the first interactive interface segment for the first action, providing the interactive element query to the RAG database, and receiving the interactive element heatmap of the first interactive interface the segment for the first action. In some instances, the interactive element heatmap indicates usage of interactive elements by a group of users visiting the first interactive interface segment.

In some implementations, act 730 includes generating a visual context prompt that includes a captured image of the first interactive interface segment from the interactive interface associated with the first action, providing the visual context prompt to the visual-based generative AI model, and receiving a visual context response from the visual-based generative AI model that includes the visual context information of the captured image. In some implementations, act 730 includes utilizing the generative AI action model to generate the interactive element query based on providing the generative AI action model with a query prompt that includes the session plan, the first action, and a set of available query filters.

As shown further, the series of acts 700 includes act 740 of providing an action execution prompt to the generative AI action model to generate an executable action scheme for accomplishing the action. For instance, in example implementations, act 740 involves providing an action execution prompt, which includes the session plan, the interactive element heatmap for the first action, and the visual context information for the first action, to the generative AI action model to generate an executable first action scheme for accomplishing the first action. In some instances, act 740 involves providing an action execution prompt, which includes the session plan, an interactive element heatmap for a first action of the set of actions, and visual context information for the first action, to the generative AI action model to generate an executable first action scheme for accomplishing the first action.

In some implementations, act 740 includes performing the executable first action scheme. In some implementations, act 740 includes receiving the executable first action scheme from the generative AI action model, performing the executable first action scheme, and verifying that the first action is successfully accomplished based on determining that a first result of performing the executable first action scheme is equivalent to the expected first action result. In some implementations, act 740 includes performing the executable first action scheme; determining that a first result of performing the executable first action scheme is not equivalent to the expected first action result; providing an updated action execution prompt, which includes the executable first action scheme, to the generative AI action model to generate an updated executable first action scheme for accomplishing the first action; performing the updated executable first action scheme; and verifying that the first action is successfully accomplished based on determining that a first updated result of performing the updated executable first action scheme is equivalent to the expected first action result.

In some implementations, act 740 includes generating the action execution prompt that includes the session plan, the interactive element heatmap for the first action, the visual context information for the first action, and the user input, providing the action execution prompt to the generative AI action model, and receiving an action response that includes the executable first action scheme for accomplishing the first action. In some implementations, act 740 includes generating a second action execution prompt that includes the session plan, an additional interactive element heatmap for a second action of the set of actions, additional visual context information for the second action, and the user input, providing the second action execution prompt to the generative AI action model, and receiving a second action response that includes an executable second action scheme for accomplishing the second action.

As further shown, the series of acts 700 includes act 750 of performing the actionable task by performing the executable action schemes related to the session plan. In some instances, in example implementations, act 750 involves performing the actionable task based on performing the executable first action scheme. In some implementations, act 750 includes performing the actionable task based on performing each action in the session plan.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 stored in the memory 803. Any of the various examples of modules and components described herein may be implemented, partially or wholly, as instructions 805 stored in memory 803 and executed by the processor 801. Any of the various examples of data described herein may be among the data 807 stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, and a data bus. For clarity, the various buses are illustrated in FIG. 8 as a bus system 819.

This disclosure describes a subjective data application system within the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or another data link that enables the transportation of electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC) and then eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Instead, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium that can be used to store desired program code means in the form of computer-executable instructions or data structures and that can be accessed by a general-purpose or special-purpose computer.

The steps and/or actions of the methods described herein may be interchanged with one another without departing from the scope of the claims. In other words, unless a specific order of steps or actions is required for the proper operation of the method being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to exclude the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for performing one or more tasks based on one or more generative artificial intelligence (AI) action models using retrieval-augmented generation (RAG) inputs, comprising:
in response to receiving user input indicating an actionable task to be automatically performed on an interactive interface, obtaining prior session information corresponding to the actionable task and the interactive interface;
providing a session plan generation prompt, which includes the prior session information, to a generative AI action model to generate a session plan that includes a set of actions for performing the actionable task;
identifying an interactive element heatmap from a RAG database and visual context information from a visual-based generative AI model for a first action from the set of actions, wherein the interactive element heatmap indicates interactive elements usage by previous users;
providing an action execution prompt, which includes the session plan, the interactive element heatmap for the first action, and the visual context information for the first action, to the generative AI action model to generate an executable first action scheme for accomplishing the first action; and
performing the actionable task based on performing the executable first action scheme.

2. The computer-implemented method of claim 1, further comprising receiving the session plan from the generative AI action model in response to the session plan generation prompt, the session plan includes the first action and an expected first action result indicating an expected result of accomplishing the first action.

3. The computer-implemented method of claim 2, further comprising:
receiving the executable first action scheme from the generative AI action model;
performing the executable first action scheme; and
verifying that the first action is successfully accomplished based on determining that a first result of performing the executable first action scheme is equivalent to the expected first action result.

4. The computer-implemented method of claim 2, further comprising:
performing the executable first action scheme;
determining that a first result of performing the executable first action scheme is not equivalent to the expected first action result;
providing an updated action execution prompt, which includes the executable first action scheme, to the generative AI action model to generate an updated executable first action scheme for accomplishing the first action;
performing the updated executable first action scheme; and
verifying that the first action is successfully accomplished based on determining that a first updated result of performing the updated executable first action scheme is equivalent to the expected first action result.

5. The computer-implemented method of claim 1, wherein:
the interactive interface includes a mobile application provided by a mobile device; and
obtaining the prior session information includes providing a query request for the prior session information corresponding to prior user sessions that interacted with the mobile application associated with mobile devices.

6. The computer-implemented method of claim 1, wherein:
the interactive interface includes a website provided by a client device; and
obtaining the prior session information includes providing a query request for the prior session information corresponding to prior user sessions that interacted with the website associated with client devices similar to the client device.

7. The computer-implemented method of claim 1, further comprising:
receiving a user query including the user input to automatically perform the actionable task on the interactive interface; and
providing one or more session information queries to the RAG database to obtain the prior session information corresponding to the actionable task and the interactive interface.

8. The computer-implemented method of claim 7, further comprising:
generating a first session information query at a first specificity level corresponding to the actionable task on the interactive interface;
generating a second session information query at a second specificity level corresponding to the actionable task on the interactive interface, wherein the first specificity level differs from the second specificity level; and
providing the first session information query and the second session information query in parallel to the RAG database.

9. The computer-implemented method of claim 1, further comprising:
generating the session plan generation prompt that includes the prior session information and the user input;
providing the session plan generation prompt to the generative AI action model; and
receiving a session plan response that includes the session plan, wherein the session plan includes the set of actions and a corresponding set of expected action results.

10. The computer-implemented method of claim 1, further comprising:
identifying a first interactive interface segment from the interactive interface associated with the first action;
generating an interactive element query for obtaining the interactive element heatmap of the first interactive interface segment for the first action;
providing the interactive element query to the RAG database; and
receiving the interactive element heatmap of the first interactive interface segment for the first action, wherein the interactive element heatmap indicates usage of interactive elements by a group of users visiting the first interactive interface segment.

11. The computer-implemented method of claim 10, further comprising:
generating a visual context prompt that includes a captured image of the first interactive interface segment from the interactive interface associated with the first action;
providing the visual context prompt to the visual-based generative AI model; and
receiving a visual context response from the visual-based generative AI model that includes the visual context information of the captured image.

12. The computer-implemented method of claim 11, further comprising utilizing the generative AI action model to generate the interactive element query based on providing the generative AI action model with a database query prompt that includes the session plan, the first action, and a set of available query filters.

13. The computer-implemented method of claim 1, further comprising:
generating the action execution prompt that includes the session plan, the interactive element heatmap for the first action, the visual context information for the first action, and the user input;
providing the action execution prompt to the generative AI action model; and
receiving an action response that includes the executable first action scheme for accomplishing the first action.

14. The computer-implemented method of claim 1, further comprising:
generating a second action execution prompt that includes the session plan, an additional interactive element heatmap for a second action of the set of actions, additional visual context information for the second action, and the user input;
providing the second action execution prompt to the generative AI action model; and
receiving a second action response that includes an executable second action scheme for accomplishing the second action.

15. The computer-implemented method of claim 1, wherein the set of actions in the session plan provides a framework for navigating through different interactive interface segments of the interactive interface to automatically accomplish the actionable task.

16. The computer-implemented method of claim 1, wherein obtaining the prior session information includes:
identifying a device type of a client device that provided a user query with the user input;
generating a query request that requests the prior session information generated by prior users with a same device type as the device type; and
providing the query request for the prior session information corresponding to the interactive interface.

17. A system comprising:
a processing system having a processor; and
a computer memory including instructions that, when executed by the processing system, cause the system to carry out operations comprising:
in response to receiving user input indicating an actionable task to be automatically performed on an interactive interface, obtaining prior session information corresponding to the actionable task and the interactive interface;
providing a session plan generation prompt, which includes the prior session information, to a generative AI action model to generate a session plan that includes a set of actions for performing the actionable task;
identifying an interactive element heatmap from a RAG database and visual context information from a visual-based generative AI model for a first action from the set of actions, wherein the interactive element heatmap indicates interactive elements usage by previous users;
providing an action execution prompt, which includes the session plan, the interactive element heatmap for the first action, and the visual context information for the first action, to the generative AI action model to generate an executable first action scheme for accomplishing the first action; and
performing the actionable task based on performing the executable first action scheme.

18. The system of claim 17, further comprising instructions that, when executed by the processing system, cause the system to carry out operations comprising:
identifying a first interactive interface segment from the interactive interface associated with the first action;
generating an interactive element query for obtaining the interactive element heatmap of the first interactive interface segment for the first action;
providing the interactive element query to the RAG database; and
receiving the interactive element heatmap of the first interactive interface segment for the first action.

19. The system of claim 18, wherein the interactive element heatmap indicates usage of interactive elements by a group of users visiting the first interactive interface segment.

20. A computer-implemented method for performing one or more tasks based on one or more generative artificial intelligence (AI) models using retrieval-augmented generation (RAG) inputs, comprising:
in response to receiving user input indicating an actionable task to be automatically performed on an interactive interface, obtaining prior session information corresponding to the actionable task and the interactive interface;
providing a session plan generation prompt, which includes the prior session information, to a generative AI action model to generate a session plan that includes a set of actions for performing the actionable task;
providing an action execution prompt, which includes the session plan, an interactive element heatmap for a first action of the set of actions, and visual context information for the first action, to the generative AI action model to generate an executable first action scheme for accomplishing the first action;
performing the executable first action scheme; and
performing the actionable task based on performing each action in the session plan.
